(19) United States
(12) Patent Application Publication
(10) Pub. No.: US 2025/0325119 A1
(43) Pub. Date: Oct. 23, 2025

(54) Piece Goods Cabinet and Method for Holding Available and Collecting Piece Goods

(71) Applicant: Deutsche Post AG, Bonn (DE)

(72) Inventors: Martin Bossek, Brühl (DE); Ralf Hormann, Bonn (DE); Dennis Kamb, Rösrath (DE)

(21) Appl. No.: 19/181,544

(22) Filed: Apr. 17, 2025

(30) Foreign Application Priority Data
Apr. 18, 2024 (DE) 10 2024 110 946.7

(51) Int. Cl. A47F 1/12; E05G 1/024; E05G 1/06

(52) U.S. Cl. CPC A47F 1/125; E05G 1/024; E05G 1/06

(57) ABSTRACT

A piece goods cabinet for holding piece goods to be collected, with a plurality of separate piece goods compartments for inserting and removing piece goods, with a control device for controlling the insertion and removal of piece goods into or from the piece goods compartments, and with an authentication device for authenticating a collector of the piece goods, wherein the piece goods compartments are each assigned a closure device which is adjustable from a closure position preventing access to the associated piece goods compartment into an open position allowing access to the associated piece goods compartment, wherein the control device is coupled to at least one locking device which is adjustable from a locked position locking a closure device in the closure position into a release position releasing the movement of the closure device into the open position, and wherein the authentication device is coupled to the control device for activating the control device upon successful authentication of the collector. So that collectors can remove piece goods more easily from the corresponding piece goods compartments, it is provided that at least some of the piece goods compartments have a rear wall unit which is movable within the associated piece goods compartment from a rear non-use position into at least one front use position for displacing a piece good contained in the associated piece goods compartment forwards in the direction of an opening of the piece goods compartment.

### CROSS-REFERENCE TO RELATED APPLICATION

This application claims priority to German Patent Application No. 10 2024 110 946.7 filed Apr. 18, 2024, the disclosure of which is hereby incorporated by reference in its entirety.

### BACKGROUND OF THE INVENTION

### Field of the Invention

The invention relates to a piece goods cabinet for holding available piece goods to be collected with a plurality of separate piece goods compartments for inserting and removing piece goods, with a control device for controlling of the insertion and removal of piece goods into or from the piece goods compartments, and with an authentication device for authenticating a collector of the piece good, wherein the piece goods compartments are each assigned a closure device which is adjustable from a closure position preventing access to the associated piece goods compartment into an open position allowing access to the associated piece goods compartment, wherein the control device is coupled to at least one locking device which is movable from a locked position locking a closure device in the closure position into a release position releasing the adjustment of the closure device into the open position, and wherein the authentication device is coupled to the control device for activating the control device upon successful authentication of the collector. Furthermore, the invention relates to a method for collecting at least one piece good from such a piece goods cabinet.

### Description of Related Art

Piece goods cabinets with a number of piece goods compartments are already known, into which individual piece goods can be inserted in order to be collected at a later time by an authorized collector. In order to ensure that the piece goods can only be collected by authorized collectors, the piece goods compartments are assigned locking devices, for example in the form of flaps or doors, which can be adjusted from a closure position preventing access to the associated piece goods compartment to an open position allowing access to the associated piece goods compartment and back again. The collector must therefore first authenticate themselves at an authentication device in order to be able to open a specific piece goods compartment. If the authentication of a collector is successful, a control device is activated in order to control a locking device that interacts with the compartment from which the piece good is to be removed by the collector. The locking device can be adjusted, controlled by the control device, from a locked position to a release position, wherein the locking device in the locked position locks the closure device in the closure position and releases the closure device in the release position for movement to the open position, in which the piece good can be removed from the respective piece goods compartment. After the piece good has been removed, the locking device can be adjusted back into the closure position and locked there by the locking device. Piece goods are placed in the piece goods compartments in the same way, wherein the piece goods cabinet assigns the piece good to the piece goods compartment to ensure that the respective piece good can only ever be collected by an authorized collector. Various known methods are available for authentication. For example, the collector can identify themselves with an ID card, a password, an OQ code or a barcode. The latter can, for example, be sent to the collector on a mobile device for each piece good when the corresponding piece good is placed in a piece goods compartment of the piece goods box.

The piece goods cabinets of the type mentioned are preferably, but not necessarily, so-called compartment systems, for example in the form of locker or parcel locker systems or electronic consignment delivery and collection systems or the like, in which piece goods, for example in the form of parcels, letters or other consignment formats, can be placed by a delivery service so that they can later be collected by collectors for whom the parcels and/or letters are intended. The collectors can be end customers and/or private individuals. The delivery service typically places several piece goods in different piece goods compartments, wherein the piece goods may be intended for collection by different collectors. In individual cases, the delivery service can also place several piece goods in one piece goods compartment if they are intended for the same collector.

The piece goods cabinets of the type described can therefore be installed at a location that is publicly accessible and can be easily accessed by the collectors. The collection of piece goods from the piece goods cabinet can then take place at any time of the day and/or day of the week.

The piece goods are usually placed randomly in free piece goods compartments. It can therefore happen that a piece good placed in a piece goods compartment at the top of the piece goods cabinet is picked up by a collector of small stature or a wheelchair user. The person collecting the parcel may then have difficulty removing it from the piece goods compartment. Conversely, a very tall collector or a collector who has difficulty bending down for health reasons may have to pick up a piece good by chance from a lower piece goods compartment of the piece goods cabinet. In this case, too, the collector may have difficulty removing it from the piece goods compartment.

### SUMMARY OF THE INVENTION

Therefore, the present invention is based on the object of designing and developing the piece goods cabinet and the method of the type mentioned at the outset and explained in more detail above in such a way that at least some collectors can more easily remove the piece goods intended for them from the corresponding piece goods compartments.

This object is solved in a piece goods cabinet as described herein in that at least some of the piece goods compartments have a rear wall unit, which is movable within the associated piece goods compartment from a rear non-use position into at least one front use position, for moving a piece good contained in the associated piece goods compartment forwards in the direction of an opening of the piece goods compartment.

The stated object is further solved by a method for collecting at least one piece good from a piece goods cabinet as described herein,
in which a collector authenticates at an authentication device as being authorized to collect a piece good from a piece goods compartment of the piece goods cabinet,
in which the control device, after authentication, moves a locking device from a locked position locking a closure device in a closure position into a release position releasing the closure device into an open position,
in which an actuating device of the piece goods compartment is grasped by the collector after the closure device has been adjusted into the open position,
in which the collector displaces a rear wall unit of the piece goods compartment by means of the actuating device from a rear non-use position into at least one front use position and thereby displaces the piece good at least in part together with the rear wall unit in the piece goods compartment forwards into a front position, and
in which the piece good is manually removed from the front position out of the piece goods compartment by the collector.

In order to facilitate grasping a piece good in a piece goods compartment, the corresponding piece goods compartment can be provided with a rear wall unit which can be moved from a rear non-use position to a front use position. By moving the rear wall unit accordingly, a piece good that is far back in the piece goods compartment can be moved forwards towards the opening of the piece goods compartment, where it can be grasped more easily than in the previous rear position. In practice, it also often happens that the piece goods slide further back than necessary when they are carelessly placed in the piece goods compartments, so that without a movable rear wall unit, it is necessary to reach very far into the piece goods compartment in order to remove the piece good from the piece goods compartment. Depending on the collector, this can be particularly difficult if the piece goods compartment is located high up or low down in the piece goods cabinet. By using the rear wall unit, however, collectors of small or very small stature can still remove packages from a compartment that is positioned high up. Similarly, very tall people can use the back panel unit to remove piece goods from compartments located at the bottom without any problems.

According to the method, this may be achieved by the collector first authenticating themselves at an authentication device as being authorized to collect a piece good from a piece goods compartment of the piece goods cabinet. If authentication is successful, a control device can then activate a locking device, which is then adjusted from a locked position to a release position. While the locking device in the locked position locks a closure device in a closure position, the locking device releases the closure device in the release position in order to be adjusted from the closure position, which prevents access to the piece goods compartment, to an open position, in which access to the piece goods compartment and thus to the piece good placed therein is generally enabled.

First of all, however, according to the method an actuating device of the piece goods compartment is grasped by the collector when the closure device has been adjusted to the open position. This adjustment can, for example, be performed manually by the collector themselves or the closure device is spring-loaded in the closure position in such a way that moving the locking device from the locked position to the release position causes the closure device to be automatically moved to the open position.

The actuating device is coupled to the rear wall unit. This allows the collector to move the rear wall unit from the rear non-use position to the front use position by means of the actuating device. This then causes the piece good in the piece goods compartment to be moved together with the rear wall unit from the rear to the front in the direction of the opening of the piece goods compartment. The piece good in the corresponding piece goods compartment is then grasped manually by the collector and removed from the piece goods compartment.

Finally, the collector can move the rear wall unit back to the rear non-use position by means of the actuating device if required, if this does not happen any way and without further action by the collector. Independently of this, the collector can also move the closure device back into the closure position, in which the locking device automatically or in any way moves from the release position back into the locked position, in which the closure device is locked in the closure position.

In order to be able to operate the piece goods cabinet flexibly, it is advisable for each piece goods compartment to be provided with an associated closure device. It may also be advisable if a locking device is assigned to each closure device. However, a common locking device can also be assigned to several closure devices. However, the common locking device will then preferably enable the separate locking and release of each individual closure device. The locking devices used for this purpose are known, for example, from locker systems or the like.

In a first, particularly preferred configuration of the piece goods cabinet, the rear wall unit is coupled to the piece goods compartment via at least one spring means. This coupling causes that the rear wall unit can automatically move from the at least one front use position back to the rear non-use position. This is possible, for example, if the collector does not actively prevent the rear wall unit from doing so and/or if the rear wall unit is not fixed in the front use position. The rear wall unit thus automatically returns from the at least one front use position to the rear non-use position in an otherwise unloaded state. To ensure that this happens in a way gentle on the piece goods cabinet, a damping element can be provided to ensure that the rear wall unit moves back slowly. Alternatively or additionally, an end stop with an elastic damping element can also be provided, which comes into contact with the rear wall unit when the rear wall unit is in the vicinity of the rear non-use position.

In order to simplify the movement of the rear wall unit from the rear non-use position to the front use position, it can be useful if the rear wall unit is connected to an actuating device to be grasped by the collector. The connection can be provided in such a way that the rear wall unit is movable from the rear non-use position to the at least one front use position via the actuating device. This can be achieved, for example, by the collector pulling on the actuating device, preferably in a direction at least substantially parallel to the movement of the rear wall unit to be effected from the rear to the front.

The actuating device can have a handle, a handle bar, a knob or a ring for grasping by the collector. In addition, the actuating device can be rigidly connected to the back panel unit, for example by a rod or a strip. However, a flexible connection loadable only by tension is also conceivable, for example comprising a rope or wire. Irrespective of the respective design of the actuating device, the actuating device can, alternatively or additionally to the rear wall unit, come into contact with an end stop comprising an elastic damping element when the rear wall unit is in the vicinity of the rear non-use position in order to damp the rearward movement of the rear wall unit.

To ensure a defined and easy movement of the rear wall unit, the piece goods compartment can have several guide rails. For space reasons, these are located on the opposite side walls of the piece goods compartment, for example. If necessary, the rear wall unit can then be connected to the guide rails via at least one slide element so as to be movable along the guide rails. For the sake of simplicity, in many cases it will also make sense if each guide rail is assigned a slide of the rear wall unit. Irrespective of this, it may be expedient if the at least one damping element of the rear wall unit interacts with at least one guide rail or is integrated into the at least one guide rail.

In order not to impair the actual function of the piece goods compartments and thus of the piece goods cabinet, it is advisable for the rear wall unit to be accommodated completely within the piece goods compartment in the non-use position. For the same reason, it is also preferable if the rear wall unit, together with the actuating element, is completely accommodated within the piece goods compartment in the non-use position.

To ensure that the piece goods cabinet can be operated as easily as possible by the collectors, it is advisable for the upper and/or lower piece goods compartments to have a rear wall unit and, if necessary, an additional actuating device. Removing piece goods from such piece goods compartments can otherwise be particularly cumbersome. In order to be able to design the piece goods cabinet simply and cost-effectively, only the upper and/or lower piece goods compartments can have a rear wall unit and, if required, an actuating device.

If the piece goods cabinet has higher piece goods compartments and lower piece goods compartments, it may alternatively or additionally be advisable for lower piece goods compartments to have a rear wall unit and, if necessary, an actuating device. Otherwise, it can be difficult to remove a piece good that is located far back in a low piece goods compartment from the piece goods compartment. To prevent the piece goods cabinet from becoming too complex and expensive, only lower piece goods compartments can have a rear wall unit if this is desired.

In a first particularly preferred embodiment of the method, the rear wall unit automatically moves back from the at least one front use position into the rear non-use position via a spring means. This can take place, for example, when the collector releases the actuating device, which will typically take place when the collector has moved the piece good to be collected with the rear wall unit so far forward in the direction of the opening that they can easily grasp the piece good. The rearward movement of the rear wall unit from the front use position to the rear non-use position can be damped by a damping element, as described above in conjunction with the piece goods cabinet.

When the rear wall unit and, if required, also the actuating device are moved back to the rear non-use position, the rear wall unit and, if required, also the actuating device are preferably completely accommodated in the piece goods compartment. The closure device can then be returned to the closure position without being obstructed by the rear wall unit and, if necessary, also by the actuating device.

Moving a piece good forward in a piece goods compartment can be accomplished very effortlessly by means of the rear wall unit if the rear wall unit is moved from the rear non-use position to a front use position and back via at least one slide element along guide rails of the piece goods compartment. A slide can be assigned to each guide rail. In addition, the at least one slide element and/or the guide rails can have rollers for sliding against each other.

It can be practical if a collector can authenticate themselves at an authentication device as being authorized to collect several piece goods from several piece goods compartments of the piece goods cabinet, wherein the control device then moves at least one locking device after authentication from a locked position locking several closure devices in a closure position into a release position releasing the closure devices into an open position. After the closure devices have been moved into the open position, a plurality of actuating devices of several piece goods compartments can be grasped in succession by the collector, wherein the collector moves the rear wall units of the piece goods compartments from the rear non-use position into the front use position by means of the actuating devices and in doing so the piece goods are displaced at least in part together with the rear wall units in the piece goods compartments forwards into a front position in the direction of the openings of the piece goods compartments. The piece goods can then be manually removed from the front positions out of the piece goods compartments by the collector. Such a procedure therefore makes it possible to remove piece goods from a large number of compartments without the need for re-authentication. This is particularly useful for an employee of a delivery service wishing to remove and take away a large number of piece goods placed in the piece goods compartment by many different customers at the same time.

### BRIEF DESCRIPTION OF THE DRAWINGS

The terms Fig., Figs., Figure, and Figures are used interchangeably in the specification to refer to the corresponding figures in the drawings.

In the following, the invention is explained in more detail with reference to a drawing showing only example embodiments. The drawing show

FIG. 1 a front view of a first piece goods cabinet according to the invention,

FIG. 2A-B a perspective view of a piece goods compartment of the piece goods cabinet from FIG. 1 with a closure device in the open position,

FIG. 3A-C a side sectional view of the piece goods compartment from FIG. 2 in different positions during the removal of a piece good,

FIG. 4 an alternative piece goods compartment in a side sectional view,

FIG. 5 a top view of a further alternative compartment for piece goods with a closure device in the open position, and

FIG. 6A-B a side sectional view of the piece goods compartment from FIG. 5 in different positions during the removal of a piece good.

### DESCRIPTION OF THE INVENTION

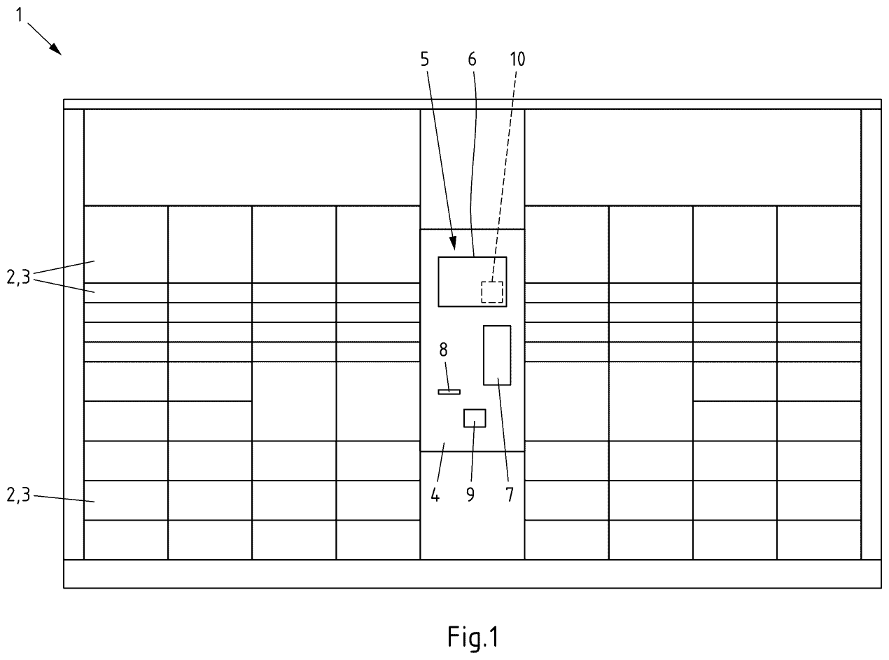

FIG. 1 shows an example piece goods cabinet 1 with a large number of piece goods compartments 2. Some of the piece goods compartments 2 are of different sizes and some are arranged at different heights. Each piece goods compartment 2 is closed with a closure device 3 so that unauthorized persons cannot access the piece goods compartments 2 and any piece goods they may contain. However, the closure devices 3 can be adjusted from the closure positions shown into open positions, in which the closure devices 3 allow access to the associated piece goods compartments 2 and any piece goods they may contain. In order to be able to move the closure devices 3 from the closure position to the open position, a locking device must first be adjusted from a locked position, in which the locking device locks the closure device 3 in the closure position, into a release position, in which the locking device releases the closure device 3 for movement to the open position.

However, such a movement of the locking device first requires authentication of a collector who is authorized to collect a piece good from a piece goods compartment 2. After authentication, however, the person collecting the piece good may then only be able to unlock the locking device for this piece goods compartment 2 and thus move the associated closure device of this piece goods compartment 2 to the open position. If necessary, further authentication is required to collect another piece good from another piece goods compartment 2 of the same piece goods cabinet 1.

In the piece goods cabinet 1 shown and preferred in this respect, an operator terminal 4 is provided in the middle of the piece goods cabinet 1 for the purpose of authentication, among other things. However, this operator terminal 4 could also be provided at a different location or in a different manner. By means of an authentication device 5, the operator terminal 4 allows a collector of a piece good provided in one of the piece goods compartments 2 to authenticate themselves as authorized to collect this particular piece good. A monitor 6, which may have a touch display, is provided for communication between the collector and the piece goods cabinet 1. Otherwise or additionally, a keypad 7 can also be provided, with which the collector can make the necessary entries. For this purpose, a scanner 8 is provided on the piece goods cabinet 1 shown, which scans a barcode of the collector, which has been transmitted to the collector for the purpose of collecting the corresponding piece good, for example on a mobile end device, such as a cell phone.

Further, a receipt printer 9 is provided in the illustrated and in this respect preferred piece goods cabinet 1, which can print out a receipt for the person collecting the piece good. Alternatively or additionally, it can also be provided that a piece good is placed in a piece goods compartment 2 of the piece goods cabinet 1 for collection. Alternatively or additionally, the receipt printer 9 can also print a receipt for this purpose, in particular if the insertion of piece goods into piece goods compartments 2 is subject to a charge. The receipt can, for example, document that the corresponding payment has been made. In principle, the operator terminal 4 can also be designed and equipped differently. This takes account of the fact that piece goods cabinets 1 can be operated in different ways and by different people.

The authentication device 5 is coupled to a control device 10, which in turn is coupled to a locking device. The control device 10 controls the locking device when the authentication of the collector has been successfully completed. The control device 10 can also control the authentication process. The locking device can be adjusted back and forth between a locked position and a release position. In the locked position, the locking device locks a closure device 3 in a closure position. In the release position, the locking device releases the closure device 3 for movement into the open position. The locking device can either selectively lock each individual closure device 3 of the piece goods cabinet 1 in the closure position or release it for movement to the open position. If necessary, the locking device can also release several closure devices 3 simultaneously for movement to the open position. The locking device is not shown in FIG. 1.

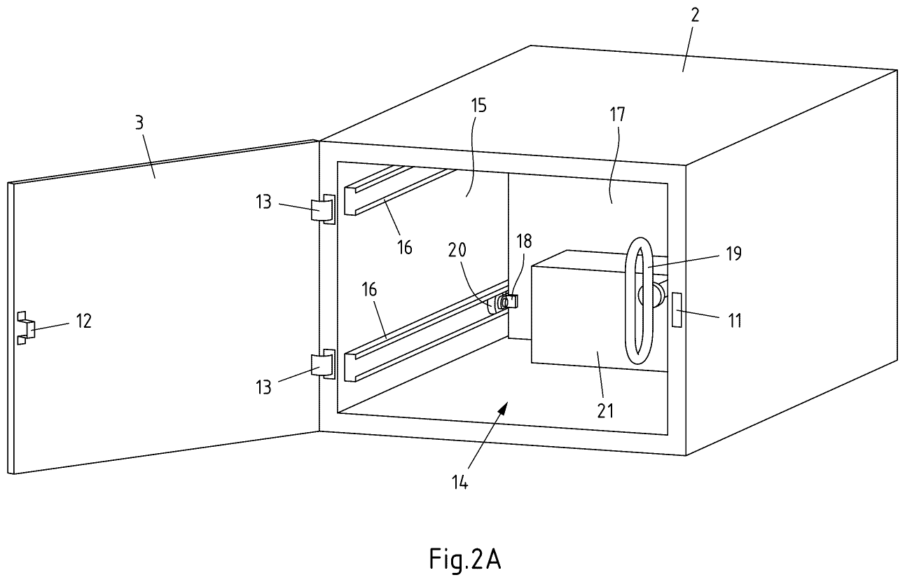

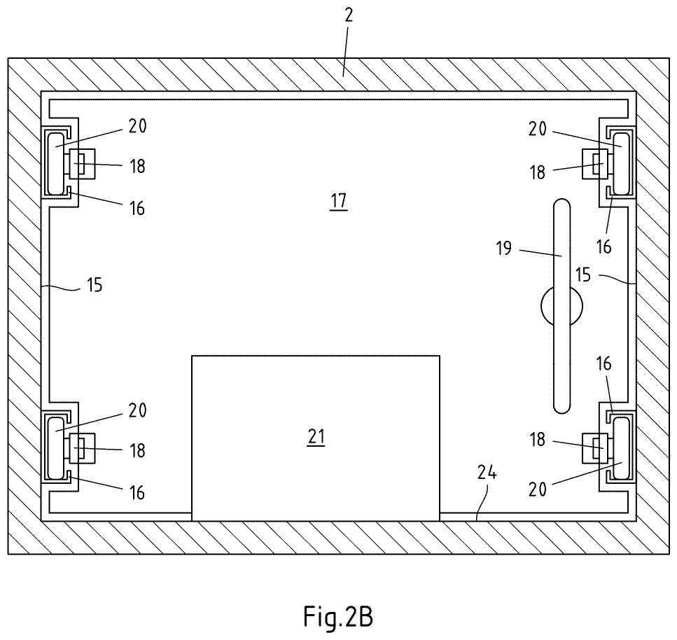

FIG. 2A-B show a piece goods compartment 2 of the piece goods cabinet 1 in a perspective view and a sectional view from the front. The closure device 3 is in the open position. The locking device 11 shown, which is preferred in this respect, is nevertheless in the locked position. When the closure device 3 is adjusted back into the closure position, the locking device 11 is deflected and then comes into engagement with a catch 12 of the closure device 3, which is designed in the form of a door in the illustrated and in this respect preferred piece goods cabinet 1. To move the closure device 3 into the closure position, the closure device 3 is pivoted about the laterally mounted hinges 13 in the direction of the opening 14 of the piece goods compartment 2 until the closure device 3 closes the opening 14. Instead of the hinges 13, a single hinge or another pivot unit could also be provided.

Two guide rails 16 are provided on each of the side walls 15 of the piece goods compartment 2, along which a rear wall unit 17 of the piece goods compartment 2 can be moved. For this purpose, the rear wall unit is connected to the guide rails 16 via slide elements 18 and also to an actuating device 19. The illustrated and in this respect preferred actuating device 19 is in the form of a handle with an engagement opening. The slide elements 18 of the rear wall unit 17 have rollers 20, which can be moved along the guide rails 16 together with the rear wall unit 17. Between the rear wall unit 17, which is arranged in a rear non-use position, and the front opening 14 of the piece goods compartment 2, a piece good 21 is arranged in the piece goods compartment 2. When viewed from the front, the rear wall unit 17 covers at least substantially the entire rear wall 22 of the piece goods compartment 2.

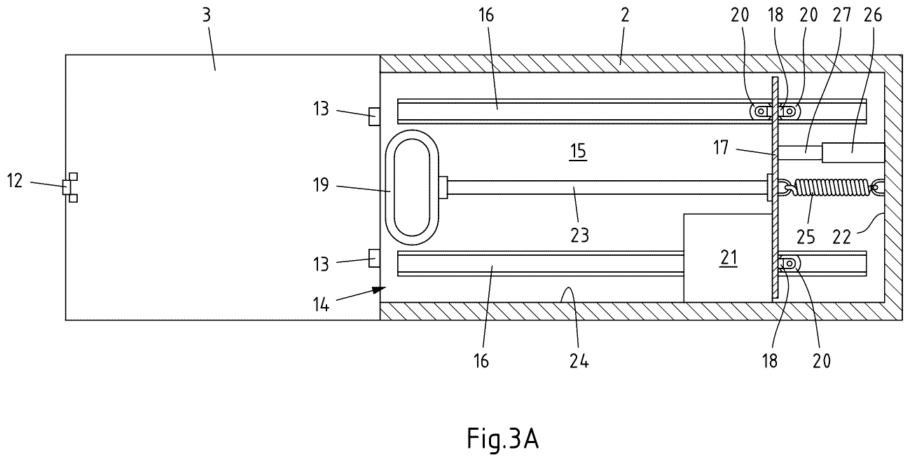

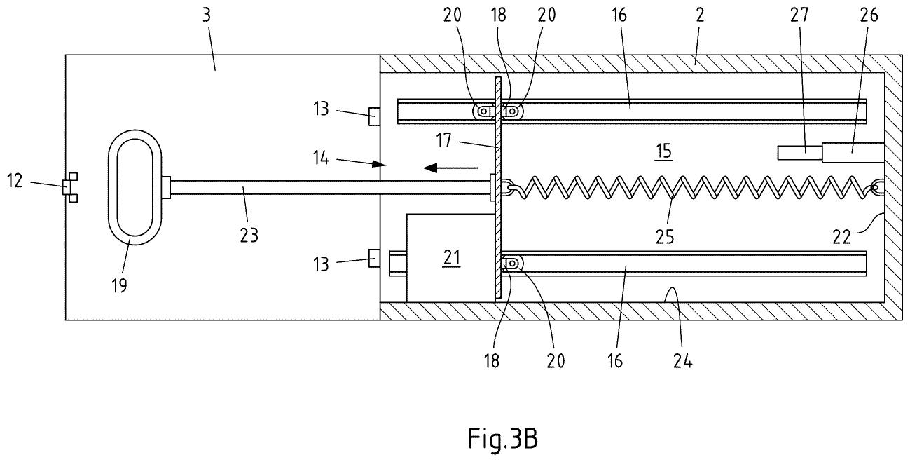

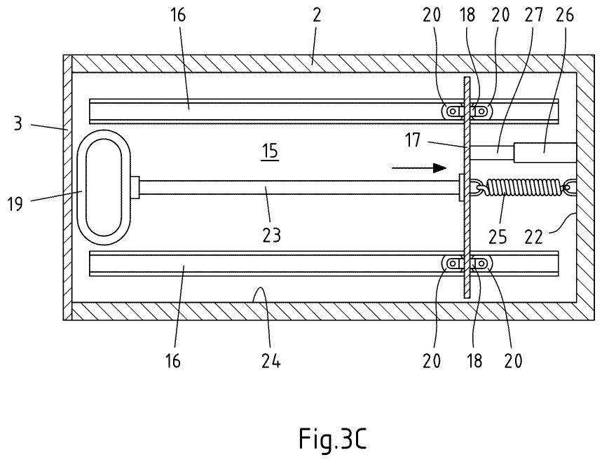

As shown in particular in FIG. 3A-C, the actuating device 19 is firmly connected to the rear wall unit 17 via a rod 23. The actuating device 19 could, for example, also be provided in the vicinity of the bottom 24 of the piece goods compartment 2, which could be particularly suitable for piece goods compartments 2 located high up, as the actuating device 19 can then possibly be grasped more easily. The rear wall unit 17 is also connected to the rear wall 22 of the piece goods compartment 2 with the aid of a spring means 25. If the actuating device 19 is grasped by a collector in the rear position shown in FIG. 3A and pulled out of the opening 14 of the piece goods compartment 2, the rear wall unit 17 is moved from the rear non-use position to the front use position shown in FIG. 3B.

The exact location of the front use position in relation to the piece goods compartment 2 and/or the opening 14 of the piece goods compartment 2 depends on how far forward the collector pulls the actuating device 19. It would not even be necessary to pull the actuating device 19 out of the opening 14. However, this is preferable. The rear wall unit 17 should be moved so far forward that the piece good 21 is consequently displaced so far forward that it can be easily grasped by the collector, even if the piece goods compartment 2 is located far up or far down in the piece goods compartment 1.

Before actually removing the piece good 21 from the piece goods compartment 2, the collector releases the actuating device 19, whereupon the loaded spring means 25 pulls the rear wall unit 17 back into the rear non-use position shown in FIG. 3C as a result of the restoring force of the spring means 25. In the area of the rear non-use position, the rear wall unit 17 can come into contact with an end stop 26, which has an elastic damping element 27. If the rear wall unit 17 is arranged in the rear non-use position, the actuating device 19 is also arranged inside the piece goods compartment 2, so that the closure device 3 can be adjusted into the closure position and locked there via the locking device 11.

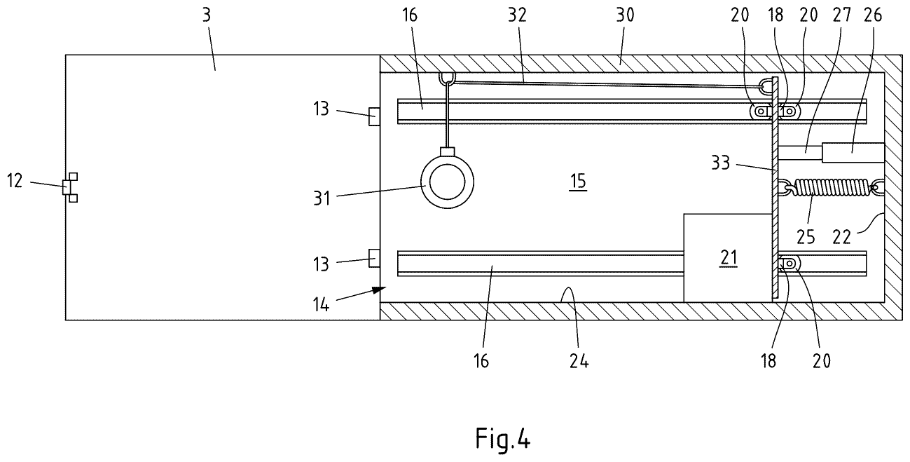

FIG. 4 shows an alternative piece goods compartment 30 in a side sectional view. This piece goods compartment 30 differs substantially from the piece goods compartment 2 in the actuating device 31 shown in FIGS. 2 and 3. The actuating device 31 of FIG. 4 has a ring for grasping or engagement by the collector, which is connected to the rear wall unit 33 via a cable 32, in particular a steel cable. When the collector pulls the actuating device 31 forwards, i.e., in the direction of the opening 14 of the piece goods compartment 30 and beyond, the rear wall unit 33 moves forwards together with the piece good 21 in the piece goods compartment 30, so that the piece good 21 can be easily removed from the piece goods compartment 30. The function of the piece goods compartment 30 therefore corresponds in principle to the function of the piece goods compartment 2 as shown in FIGS. 2 and 3 and therefore requires no further detailed explanation.

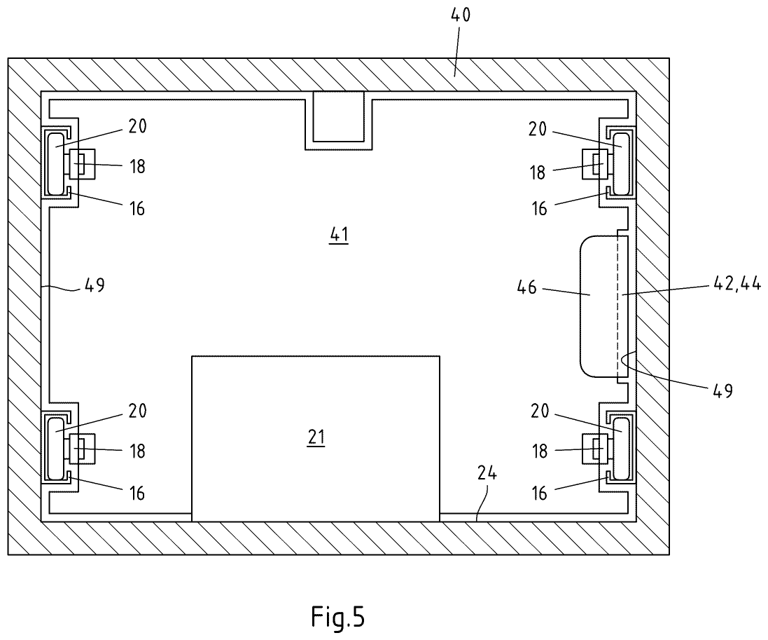

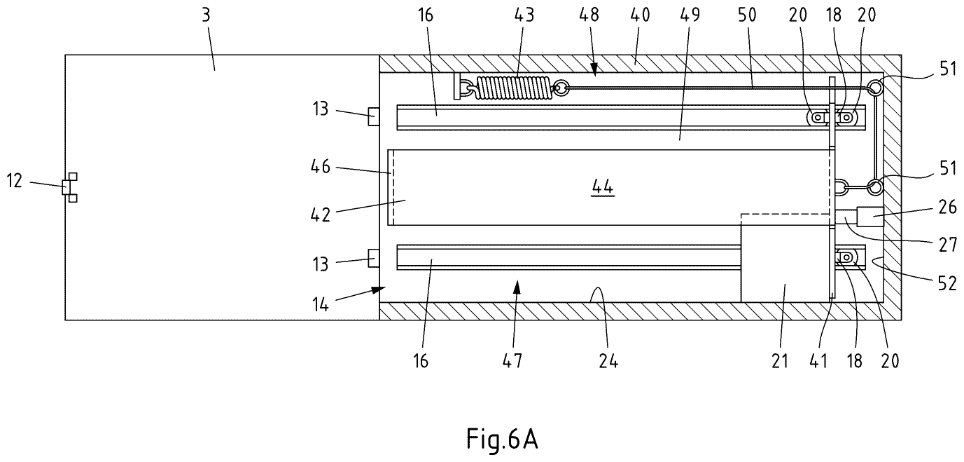

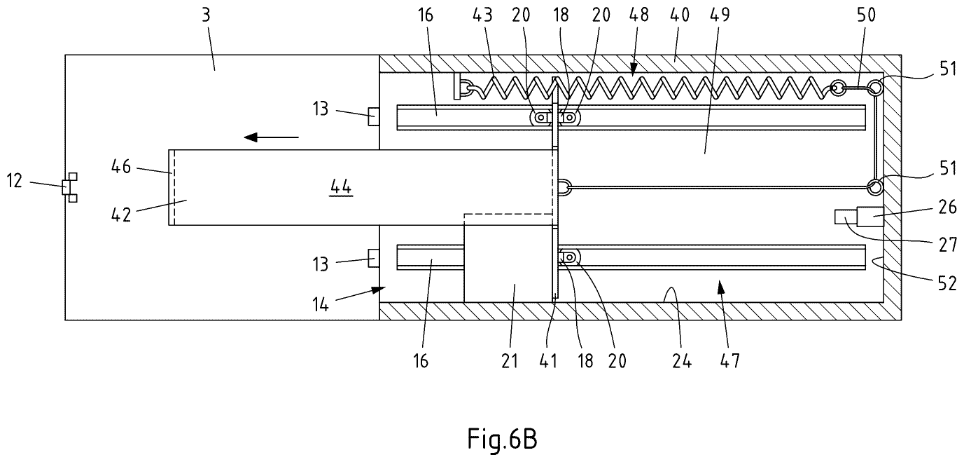

FIG. 5 shows another, alternative piece goods compartment 40 in a sectional view from the front. In its function, the piece goods compartment 40 is similar to the two piece goods compartments 2, 30 described above, wherein the piece goods compartment 40 itself and the rear wall unit 41 between the two piece goods compartments 2, 30 described above and the piece goods compartment 40 of FIG. 5 are at least comparable. The key difference consists in the actuating device 42 on the one hand and in the arrangement of the spring means 43 on the other hand, as shown in FIGS. 6A-B in a side sectional view.

The rear wall unit 41 is formed from a sheet metal, from which a tab 44 is folded forward. The tab 44 serves as the actuating device 42, which is bent again at the front end and thus forms a kind of handlebar 46. In this way, the receiving space 47 of the piece goods compartment 40 is only slightly restricted. In order to be able to use the depth of the piece goods compartment 40 as extensively as possible, the spring means 43 for moving the rear wall unit 41 back from a front use position into the rear non-use position shown in FIG. 6A is provided at least partially between the rear wall unit 41 and the opening 14 of the piece goods compartment 40.

In the illustrated and in this respect preferred piece goods compartment 40, the spring means 43 is arranged in the ceiling area 48 of the piece goods compartment 40, where it will hardly interfere in most cases. However, the spring means 43 could also be provided on a side wall 49 or on the base 24. The spring means 43 is connected to the rear of the rear wall unit 41 via a cable 50, in particular a wire cable, and via deflection eyelets 51. Instead of the deflection eyelets 51, deflection rollers could also be provided in order to achieve even easier movement of the rear wall unit 41. By arranging the spring means 43 at least partially in front of the rear wall unit 41, which is located in the rear non-use position, the rear wall unit 41 can be arranged closer to the rear wall 52 of the piece goods compartment 40 in the non-use position than in the two piece goods compartments 2, 30 described above.

When the actuating device 42 is grasped and pulled forwardly, partially out of the opening 14 of the piece goods compartment 40, the rear wall unit 41 moves to a forward use position, as shown in FIG. 6B. Together with the rear wall unit 41, the piece goods 21 are displaced by the rear wall unit 41 from a rear position to a front position close to the opening 14 of the piece goods compartment 40, where the piece goods 21 can be easily removed from the piece goods compartment 40. The spring means 43 extends backwards in the direction of the rear wall 52 of the piece goods compartment 40. The rear wall unit 41 has a recess 53 at the upper edge in order to be able to move the rear wall unit 41 completely forwards despite the spring means 43 arranged in the ceiling area 48.

### List of Reference Signs

1 piece goods cabinet
2 piece goods compartment
3 closure device
4 operator terminal
5 authentication device
6 monitor
7 keypad
8 scanner
9 receipt printer
10 control device
11 locking device
12 catch
13 hinge
14 opening
15 side wall
16 guide rail
17 rear wall unit
18 slide element
19 actuating device
20 roller
21 piece good
22 rear wall
23 rod
24 bottom
25 spring means
26 end stop
27 damping element
30 piece good compartment
31 actuating device
32 rope
33 rear wall unit
40 piece good compartment
41 rear wall unit
42 actuating device
43 spring means
44 tab
46 handle bar
47 receiving space
48 ceiling area
49 side wall
50 rope
51 deflection eyelets
52 rear wall

1. A piece goods cabinet for holding available piece goods to be collected, with a plurality of separate piece goods compartments for inserting and removing piece goods, with a control device for control of the insertion and the removal of piece goods into or from the piece goods compartments, and with an authentication device for authenticating a collector of the piece good, wherein the piece goods compartments are respectively assigned a closure device which is movable from a closure position preventing access to the associated piece goods compartment into an open position allowing access to the associated piece goods compartment, wherein the control device is coupled to at least one locking device which is movable from a locked position locking a closure device in the closure position into a release position releasing the movement of the closure device into the open position, and wherein the authentication device is coupled to the control device for activating the control device upon successful authentication of the collector,
wherein
at least some of the piece goods compartments have a rear wall unit which is movable within the associated piece goods compartment from a rear non-use position into at least one front use position for displacing a piece good contained in the associated piece goods compartment forwards in the direction of an opening of the piece goods compartment.

2. The piece goods cabinet according to claim 1,
wherein
the rear wall unit is coupled to the piece goods compartment via a spring means in such a way that the rear wall unit automatically moves back from the at least one front use position into the rear non-use position in the unloaded state.

3. The piece goods cabinet according to claim 1,
wherein
the rear wall unit is connected to an actuating device to be grasped by the collector in such a way that the rear wall unit is movable from the rear non-use position into the at least one front use position via the actuating device.

4. The piece goods cabinet according to claim 1,
wherein
the actuating device has a handle, a handle bar, a knob or a ring for grasping by the collector, and/or that the actuating device is connected to the rear wall unit rigidly, preferably via a rod or a strip, or flexibly, preferably by a connection which is loadable only by tension, in particular comprising a cable or a wire.

5. The piece goods cabinet according to claim 1,
wherein
the piece goods compartment has a plurality of guide rails, in particular on the mutually opposite side walls of the piece goods compartment, and that, preferably, the rear wall unit is connected to the guide rails movably along the guide rails via at least one slide element.

6. The piece goods cabinet according to claim 1,
wherein
the rear wall unit in the non-use position, in particular together with the actuating device, is completely accommodated within the piece goods compartment.

7. The piece goods cabinet according to claim 1,
wherein
upper and/or lower piece goods compartments have a rear wall unit, and that, preferably, only upper and/or lower piece goods compartments have a rear wall unit.

8. The piece goods cabinet according to claim 1,
wherein
higher piece goods compartments and lower piece goods compartments are provided, and that, preferably only, lower piece goods compartments have a rear wall unit.

9. A method for collecting at least one piece good from a piece goods cabinet according to claim 1,
wherein a collector authenticates at an authentication device as being authorized to collect a piece good from a piece goods compartment of the piece goods cabinet,
wherein the control device, after authentication, moves a locking device from a locked position locking a closure device in a closure position into a release position releasing the closure device into an open position,
wherein an actuating device of the piece goods compartment is grasped by the collector after the closure device has been adjusted into the open position,
wherein the collector displaces a rear wall unit of the piece goods compartment by means of the actuating device from a rear non-use position into at least one front use position and thereby displaces the piece good at least in part together with the rear wall unit in the piece goods compartment forwards into a front position, and
wherein the piece good is manually removed from the front position out of the piece goods compartment by the collector.

10. The method according to claim 9,
wherein the rear wall unit automatically moves back from the at least one front use position into the rear non-use position via a spring means after release of the actuating device by the collector.

11. The method according to claim 9,
wherein the rear wall unit and the actuating device are completely accommodated in the piece goods compartment in the rear non-use position.

12. The method according to claim 9,
wherein the rear wall unit is displaced via at least one slide element along guide rails of the piece goods compartment from the rear non-use position into a front use position and back.

13. The method according to claim 9,
wherein a collector authenticates themselves at an authentication device as being authorized to collect a plurality of piece goods from a plurality of piece goods compartments of the piece goods cabinet,
wherein the control device, after authentication, adjusts at least one locking device from a locked position locking a plurality of closure devices in a closure position into a release position releasing the closure device into an open position,
wherein a plurality of actuating devices of a plurality of piece goods compartments are grasped in succession by the collector after the closure devices have been adjusted into the open position,
wherein the collector moves rear wall units of the piece goods compartments from rear non-use positions into front use positions by means of the actuating devices and thereby the piece goods are displaced at least in part together with the rear wall units in the piece goods compartments forwards into a front position, and
wherein the piece goods are manually removed from the front positions out of the piece goods compartments by the collector.
